(19) United States
(12) Patent Application Publication
(10) Pub. No.: US 2011/0174948 A1
(43) Pub. Date: Jul. 21, 2011

(54) Device for Hanging Curtain Rods

(75) Inventors: Denise Ward, Ft. Myers, FL (US); Lori Christy, Naples, FL (US)

(73) Assignee: UNIQ DEZINZ, INC., Estero, FL (US)

(21) Appl. No.: 13/010,913

(22) Filed: Jan. 21, 2011

Related U.S. Application Data
(60) Provisional application No. 61/297,198, filed on Jan. 21, 2010.

(51) Int. Cl. A47H 1/122; F16M 13/00; A47H 1/102

(52) U.S. Cl. 248/265; 248/288.11; 248/262

(57) ABSTRACT

A device for hanging curtain rods is disclosed. In one embodiment, a device includes a mounting base, a post coupled to the mounting base, an adjustable sleeve designed to adjustably operatively engage the post, and a front portion coupled to the adjustable sleeve. In another embodiment, a device includes a double L-shaped bracket and a front portion that is designed to be removably coupled to one end of the double L-shaped bracket. In still another embodiment, a device includes a mounting base, a post coupled to the mounting base, and a front portion coupled to the post. The front portion in any of the embodiments may be one of many decorative faces contained in a kit. The kit may contain such suitable decorative faces, including but not limited to, a heart, a basketball, a crown, or any suitable combination or variation thereof.

### CROSS-REFERENCE TO RELATED APPLICATIONS

This application incorporates by reference and claims priority to U.S. provisional patent application Ser. No. 61/297.198 filed Jan. 21, 2010.

### BACKGROUND

A wide variety of devices are used to permit the mounting and/or placement of drapery rods and the like. These devices include various brackets and other mounting hardware. To date however, all such devices do not permit both the mounting of drapery hardware while simultaneously permitting the mounting of additional ornamental decoration and/or additional hardware. Thus, there is a need in the art for an improved mounting device for drapery hardware that enables a user to achieve multiple decorative goals.

### BRIEF SUMMARY

The disclosure relates to a device for hanging curtain rods, drapery rods, curtains, drapes, roping and/or other types of window dressing and/or hardware (hereafter called curtain rods). In one embodiment, a device comprises: a mounting base, a post coupled to the mounting base, an adjustable sleeve designed to adjustably operatively engage the post, and a front portion coupled to the adjustable sleeve. In another embodiment, a device according to the present invention comprises: a double L-shaped bracket and a front portion that is designed to be removably coupled to one end of the double L-shaped bracket.

### BRIEF DESCRIPTION OF THE DRAWINGS

FIG. 1 is an illustration of a device according to one embodiment.

FIG. 1(a) is an illustration of a component of the device of FIG. 1.

FIG. 2 is an illustration of a device according to another embodiment.

FIG. 3 is an illustration of a device according to another embodiment.

FIGS. 4-6 are illustrations of a component of a device according to one embodiment.

### DETAILED DESCRIPTION

In one embodiment, a device comprises: a mounting base, a post coupled to the mounting base, an adjustable sleeve designed to adjustably engage the post, and a front portion coupled to the adjustable sleeve. In another embodiment, a device comprises: a double L-shaped bracket and a front portion that is designed to be removably coupled to one end of the double L-shaped bracket. As used herein, the term window dressing includes, but is not limited to, drapery, sashes, tie-backs. curtains, and drapery and/or curtain hardware.

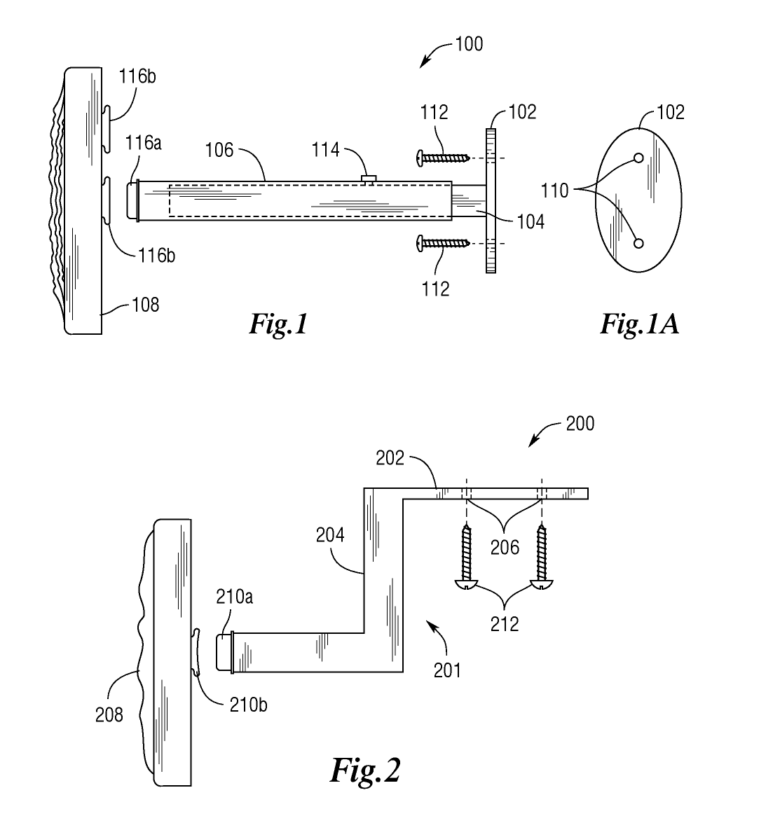

In reference to FIG. 1, an illustration of a device is shown. A side view of device 100 is shown comprising a base 102, post 104. adjustable sleeve 106 and front portion 108. As can be seen from FIG. 1, base 102 is designed to be mounted to a vertical surface (e.g., a wall), by any suitable mounting mechanism. Suitable mounting mechanisms include, but are not limited to, screws, bolts, nails, rivets, glue (or another type of chemical adhesive), or any suitable combination of two or more thereof. In the case where a mechanical mounting mechanism is utilized to attach base 102 to a desired vertical surface the number and/or placement of the mechanical mounting hardware is not limited to any one particular number or any one particular orientation and/or physical arrangement, so long as the front portion 108 is maintained in a spaced relatively parallel relationship with the vertical surface.

In one non-limiting example shown in FIG. 1(a), base 102 has therein two mounting holes 110 designed to receive suitable sized screws, bolts, or nails 112. However, as is noted above, device 100 and base 102 are not limited to solely this type and/or number of mounting hardware. Additionally, although base 102 is shown in FIG. 1 as having a circular shape, base 102 is not limited solely to this geometrical orientation. Rather, any geometrical shape may be used without limitation. Suitable geometric shapes include, but are not limited to, square, rectangular, circular, polygonal, triangular, elliptical, irregular, star-shaped, etc. Base 102 may be formed from any suitable material. Such suitable materials include, but are not limited to, metal (including any type of metal alloy), plastic. wood, ceramic, composite/resin. or any suitable combination of two or more thereof.

Post 104 is either permanently. or removably, mounted to base 102, extending perpendicularly away from the vertical surface. In the instance where post 104 is permanently mounted to base 102 such mounting may be accomplished by any suitable means. Such means include, but are not limited to, rivet(s), screw(s), bolt(s), nail(s), glue (or some other type of adhesive), welding, or any suitable combination of two or more thereof. Post 104 may be formed from any suitable material. Such suitable materials include, but are not limited to, metal (including any type of metal alloy), plastic. wood, ceramic, composite/resin, or any suitable combination of two or more thereof. Additionally. post 104 is not limited to any one particular geometrical orientation or cross-sectional shape. Rather, any geometrical orientation or cross-sectional shape may be used without limitation. Suitable geometric orientations and/or cross-section shapes include, but are not limited to, square, rectangular, circle, round, oval, polygonal, triangular, elliptical, irregular, star-shaped. etc.

Adjustable sleeve 106 may be removably, moveably and operatively engaged with post 104. Thus, adjustable sleeve 106 should be designed to have a similar geometrical orientation and/or cross-sectional shape as that of post 104. In another embodiment, adjustable sleeve 106 may further include a locking device 114 that enables adjustable sleeve 106 to be secured in a desired position to post 104. Suitable locking devices include, but are not limited to, a screw, a bolt, or a tab/slot arrangement. The adjustable sleeve 106 may be formed from any suitable material. Such suitable materials include, but are not limited to, metal (including any type of metal alloy), plastic, wood. ceramic, composite/resin, or any suitable combination of two or more thereof. Additionally, adjustable sleeve 106 is not limited to any one particular geometrical orientation or cross-sectional shape. Rather, any geometrical orientation or cross-sectional shape may be used without limitation. Suitable geometric orientations and/or cross-section shapes include, but are not limited to, square, rectangular, round, oval, polygonal, triangular, elliptical. irregular, star-shaped, etc.

Front portion 108 may be removably, and operatively engaged with one end of adjustable sleeve 106. In another embodiment, front portion 108 may further include an attachment portion that enables front portion 108 to be secured to adjustable sleeve 106. Suitable attachment portions include, but are not limited to, a screw, a bolt, a snap, hook and loop fasteners, tab and slot, tongue and groove, dowel and hole, etc. In one embodiment, a snap, or industrial strength snap, is utilized where such snap is composed of a male portion 116a and a female portion 116b. It should be noted that the placement of the male and female portions of the snap is not critical and thus is not limited to any one specific placement and/or arrangement. In another embodiment, multiple halves of either the male or female portion of a snap may be utilized so as to permit multiple different or offset placements, or arrangements, of the front portion 108 (see FIG. 1).

Front portion 108 may be formed from any suitable material. Such suitable materials include, but are not limited to, metal (including any type of metal alloy), plastic, wood, ceramic, composite/resin, or any suitable combination of two or more thereof. Additionally, front portion 108 is not limited to any one particular geometrical orientation or shape. Rather, any geometrical orientation or shape may be used without limitation. Suitable geometric orientations and/or shapes include, but are not limited to, square, rectangular, sphere, cube, round, oval, polygonal, triangular, elliptical, irregular, star-shaped, etc. In another embodiment, front portion 108 may be designed to permit further decoration and/or customization by the end-user, or may come decorated and/or customized. In still another embodiment, front portion 108 may be formed from a material that may be painted, stained or have decoration glued and/or attached thereto.

In still another embodiment, front portion 108 may be one of many decorative faces contained in a kit. The kit may contain such suitable decorative faces 108, including but not limited to, a pumpkin, Christmas tree, birthday cake, heart, Easter egg, flag, star of David, basketball, football, soccer ball, baseball, volleyball, ballet slippers, dinosaur, crown, action figure, rocket, car, truck, flowers, sun, moon, star, various animals (dog, cat, bunny, turtle, monkey, horse etc) or any suitable combination or variation thereof. The kit may contain several decorative faces 108 such that the user may interchange the faces as desired.

Regarding device 100 of FIG. 1 and the component of FIG. 1(a), the disclosure is not limited to any one specific set of design dimensions. Rather, device 100 and the component shown in FIG. 1(a) may be any desired size depending on the intended end use for device 100.

In reference to FIG. 2, an illustration of a device in accordance with another embodiment is shown. As illustrated in FIG. 2, a side view of device 200 is shown comprising a double L-shaped bracket 201 and a front portion 208 that may be removably coupled to one end of the double L-shaped bracket 201. As can be seen from FIG. 2, bracket 201 includes base section 202 connected to support post 204. Base section 202 is designed to be mounted to a horizontal surface (e.g., a ceiling) by any suitable mounting mechanisms. Suitable mounting mechanism include, but are not limited to, screws, bolts, nails, rivets, glue (or another type of chemical adhesive), or any suitable combination of two or more thereof. In the case where a mechanical mounting mechanism is utilized to attach base section 202 to a desired horizontal surface the number and/or placement of the mechanical mounting hardware is not limited to any one particular number or any one particular orientation and/or physical arrangement so long as the front portion 204 is maintained in a relatively perpendicular relationship with the horizontal surface.

In one non-limiting example, base section 202 has therein two mounting holes 206 designed to receive suitable sized screws, bolts, or nails 212. However, the device 200 is not limited to solely this type and/or number of mounting hardware. Additionally, although bracket 201 is shown in FIG. 2 as having an equal double L-shape, bracket 201 is not limited to solely this orientation. Rather, any orientation whether symmetrical, or non-symmetrical, may be used without limitation. Bracket 201 may be formed from any suitable material. Such suitable materials include, but are not limited to, metal (including any type of metal alloy), plastic, ceramic, composite/resin, or any suitable combination of two or more thereof.

Front portion 208 may be removably, and operatively engaged with one end of support post 204. In another embodiment, front portion 208 may further include an attachment portion that enables front portion 208 to be secured in a desired position to device 200. Suitable attachment portions include, but are not limited to, a screw, a bolt, a snap, hook and loop fasteners, tab and slot, tongue and groove, dowel and hole, etc. In one embodiment, a snap, or industrial strength snap, is utilized where such snap is composed of a male portion 210a and a female portion 210b. It should be noted that the placement of the male and female portions of the snap is not critical and thus is not limited to any one specific placement and/or arrangement. In another embodiment, multiple halves of either the male or female portion of a snap may be utilized so as to permit varied placements or arrangements, of the front portion 208 similar to that shown with regard to front portion 108 in FIG. 1.

Front portion 208 may be formed from any suitable material. Such suitable materials include, but are not limited to, metal (including any type of metal alloy), plastic, wood, ceramic, composite/resin, or any suitable combination of two or more thereof. Additionally, front portion 208 is not limited to any one particular geometrical orientation or shape. Rather, any geometrical orientation or shape may be used without limitation. Suitable geometric orientations and/or shapes include, but are not limited to, square, rectangular, circle, sphere, cube, oval, polygonal, triangular, elliptical, irregular. star-shaped, etc.

In another embodiment, front portion 208 may be designed to permit further decoration and/or customization by the end-user, or may come decorated and/or customized. In still another embodiment, front portion 208 may be formed from a material that may be painted, stained or have decoration glued and/or attached thereto. In still another embodiment, front portion 208 may be one of many decorative faces contained in a kit. The kit may contain a plurality of decorative faces 208, including but not limited to, a pumpkin, Christmas tree, birthday cake, heart, Easter egg, flag, star of David, basketball, football, soccer ball, baseball, volleyball, ballet slippers, dinosaur, crown, action figure, car, truck, flowers, sun, moon, star, various animals (dog, cat, bunny, turtle, monkey, horse etc) or any suitable combination or variation thereof. The kit may contain several decorative faces 208 such that the user may interchange the faces as desired.

Regarding device 200 of FIG. 2, the disclosure is not limited to any one specific set of design dimensions. Rather. device 200 may be any desired size depending on the intended end use for device 200.

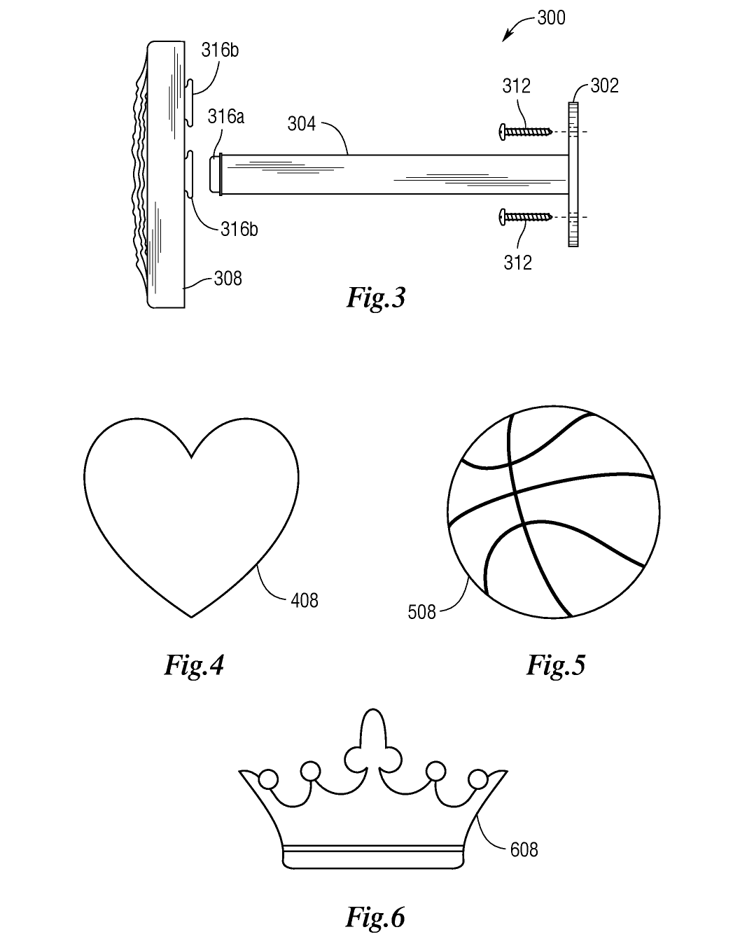

In reference to FIG. 3, an illustration of a device in accordance with another embodiment of the present invention is shown. As illustrated in FIG. 3, a side view of device 300 is shown as a modification of the device of FIG. 1, wherein the post 104, adjustable sleeve 106 and locking means 114 are replaced with a suitably sized fixed post 304. The size of fixed post 304 may be any desired length depending upon the application for device 300. Thus, this embodiment is not to be limited to any one size, or dimension, of post 304. As can be seen from FIG. 3, base 302 is designed to be mounted to a vertical surface (e.g., a wall) extending perpendicularly away from the vertical surface, by any suitable mounting means. Suitable mounting means include, but are not limited to, screws 312, bolts, nails, rivets, glue (or another type of chemical adhesive), or any suitable combination of two or more thereof. In the case where a mechanical mounting means is utilized to attach base 302 to a desired vertical surface the number and/or placement of the mechanical mounting hardware is not limited to any one particular number or any one particular orientation and/or physical arrangement. In this embodiment, front portion 308 is removably, and operatively engaged with one end of the fixed post 304. In another embodiment, front portion 308 may further include an attachment portion that enables front portion 308 to be secured in a desired position to fixed post 304. Suitable attachment portions include, but are not limited to, a screw, a bolt, a snap, hook and loop fasteners, tab and slot, tongue and groove, dowel and hole, etc. In one embodiment, a snap, or industrial strength snap, is utilized where such snap is composed of a male portion 316a and a female portion 316b. It should be noted that the placement of the male and female portions of the snap is not critical and thus is not limited to any one specific placement and/or arrangement. In another embodiment, multiple halves of either the male or female portion of a snap may be utilized so as to permit multiple different placements, or arrangements, of the front portion 308 (see FIG. 3).

Front portion 308 may be formed from any suitable material. Such suitable materials include, but are not limited to, metal (including any type of metal alloy), plastic, wood, ceramic, composite/resin, or any suitable combination of two or more thereof. Additionally, front portion 308 is not limited to any one particular geometrical orientation or shape. Rather, any geometrical orientation or shape may be used without limitation. Suitable geometric orientations and/or shapes include, but are not limited to, square, rectangular, sphere, cube, circle, oval, polygonal, triangular, elliptical, irregular, star-shaped, etc. In another embodiment, front portion 308 may be designed to permit further decoration and/or customization by the end-user, or may come decorated and/or customized. In still another embodiment, front portion 308 may be formed from a material that may be painted, stained or have decoration glued and/or attached thereto.

In reference to FIGS. 4-6, front portions 108, 208, and 308 shown in FIGS. 1-3 may be one of many decorative faces contained in a kit. The kit may contain such suitable decorative faces including but not limited to a heart 408, FIG. 4, a basketball 508, FIG. 5, and/or a crown 608, FIG. 6. The kit may contain several decorative faces such that the user may interchange the faces as desired.

Regarding device 300 of FIG. 3 and the components of FIGS. 4-6, the teachings are not limited to any one specific set of design dimensions. Rather. device 300 and the components shown in FIGS. 4-6 may be any desired size depending on the intended end use for device 300.

Although the invention has been described with reference to certain embodiments detailed herein, other embodiments can achieve the same or similar results. Variations and modifications of the invention will be obvious to those skilled in the art and the invention is intended to cover all such modifications and equivalents.

While the systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on provided herein. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicants' general inventive concept. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. When elements are described or claimed as having communication “between” the elements, such communication can be serial or parallel, one-way or two way. As used herein, “connection” or “connected” means both directly, that is, without other intervening elements or components, and indirectly, that is, with another component or components arranged between the items identified or described as being connected. Furthermore, to the extent that the term “or” is employed in the claims (e.g., A or B) it is intended to mean “A or B or both”. When the applicants intend to indicate “only A or B but not both” then the term “only A or B but not both” will be employed. Similarly, when the applicants intend to indicate “one and only one” of A, B, or C, the applicants will employ the phrase “one and only one”. Thus, use of the term “or” herein is the inclusive, and not the exclusive use. See. Bryan A. Garner, A Dictionary of Modern Legal Usage 624 (2d. Ed. 1995).

What is claimed is:

1. A mounting device comprising:
a mounting base;
a post coupled to the mounting base;
an adjustable sleeve designed to adjustably engage the post; and
a front portion coupled to the adjustable sleeve.

2. The device of claim 1, further comprising a kit containing several decorative faces.

3. The device of claim 1, wherein the front portion is coupled to the adjustable sleeve with a snap.

4. The device of claim 2, wherein the kit comprises decorative faces selected from the group consisting of a pumpkin, heart, Christmas tree, birthday cake, star of David, flag, Easter egg, basketball, football, soccer ball, baseball, volleyball, ballet slippers, rocket, car, truck, dinosaur, action figure, flowers, crown, sun, moon, star, and various animals.

5. The device of claim 1, wherein said post is perpendicular to said mounting base.

6. A kit for decoratively supporting a curtain rod comprising:
a set of brackets, each bracket comprising:
a base configured to be connected to a surface;
a support defining two ends, where a first of the two ends is connected to the base; and
a first attachment portion connected to the support adjacent a second of the two ends of the support; and
a plurality of decorative front portions, each decorative front portion comprising at least one second attachment portion configured for selective engagement with the first attachment portion connected to the support while the set of brackets are connected to the surface.

7. The kit as set forth in claim 6, where the support comprises a post directly connected to the base at the first of the two ends and directly connected to the first attachment portion at the second of the two ends.

8. The kit as set forth in claim 6, where the support comprises a post directly connected to the base at the first of the two ends and an adjustable sleeve, where the first attachment portion directly connects to the adjustable sleeve at the second of the two ends.

9. The kit as set forth in claim 6, where a decorative front portion when connected to the support is disposed in a relatively perpendicular relationship with a ceiling surface.

10. The kit as set forth in claim 6, where a decorative front portion when connected to the support is disposed in a relatively parallel relationship with a wall surface.

11. The kit as set forth in claim 6, where the first attachment portion and the second attachment portion comprise a snap or a hook and loop fastener.

12. A device for hanging a curtain rod comprising:
a mounting base;
a support connected to the mounting base; and
a front portion connected to the support by an attachment mechanism, wherein the front portion is one of several decorative faces contained in a kit.

13. The device of claim 12, wherein the kit comprises decorative faces selected from the group consisting of a pumpkin, heart, Christmas tree, birthday cake, star of David, flag, Easter egg, basketball, soccer ball, baseball, volleyball, ballet slippers, crown, rocket, car, truck, dinosaur, action figure, sun, moon, star, and various animals.

14. The device of claim 12, wherein the attachment mechanism is a snap.

15. The device of claim 12, wherein the material from which the front portion is formed is selected from the group consisting of metal, metal alloy, plastic, wood, ceramic, composite, resin, or any suitable combination thereof.

16. The device of claim 12, wherein said post has a cross-sectional shape or geometrical orientation selected from the group consisting of square, rectangle, round, oval, polygon, triangle, ellipse, irregular, and star.

17. The device of claim 12, wherein the support comprises a post disposed perpendicularly from the mounting base.

18. The device of claim 12, wherein the support comprises a double L-shaped bracket.

19. The device of claim 12, wherein the support comprises a post and an adjustable sleeve.
